(19) United States
(12) Patent Application Publication
(10) Pub. No.: US 2007/0225838 A1
(43) Pub. Date: Sep. 27, 2007

(54) Programmable Controller for use in Automation Systems

(76) Inventors: Jorg Vollmann, Adelsdorf (DE); Peter Wagner, Hersbruck (DE)

Correspondence Address: HENRY M FEIEREISEN, LLC, 350 FIFTH AVENUE, SUITE 4714, NEW YORK, NY, 10118, US

(21) Appl. No.: 11/569,906

(22) PCT Filed: May 20, 2005
(86) PCT No.: PCT/EP05/52326

§ 371 Date: Dec. 1, 2006

(30) Foreign Application Priority Data
Jun. 1, 2004 (DE) 10 2004 026 620.4

(51) Int. Cl. G05B 19/05

(52) U.S. Cl. 700/86

(57) ABSTRACT

The invention relates to a programmable controller (S) for use in automation systems, comprising a first area (A) for storing and running control codes for automation units (I, O), programmed in a first programming language, whereby a second area (B) is connected to the first area (A) via at least one interface (P). The second area (B) can be programmed in a programming language that is different from the first programming language.

The present invention relates to a programmable controller as claimed in the preamble of claim 1.

One of the applications of programmable controllers, also known as Programmable Logic Controllers (PLC) or Stored Program Controllers (SPC), is in automation engineering. They contain the suitably programmed control codes for executing the required automation functions.

Automation systems can be created using suitable tools such as Step 7 from the Siemens AG company by configuring and programming individual automation units according to the required automation system. As a rule, highly abstract programming languages are used for this, which in the past were increasingly adapted to suit the highly specialized requirements in automation engineering. Although these programming languages are familiar to the engineer designing such automation systems, such programming languages and program codes tend to be incomprehensible to a user of such automation systems. User-specific customization of the automation system without detailed technical knowledge is hence not easily possible.

Thus efforts were also made in the past to create automation systems using object oriented programming languages such as JAVA. Object-oriented languages have the advantage that they are relatively straightforward and hence easy to understand. They have the disadvantage, however, that, unlike the programming languages commonly used in automation engineering, they do not run deterministically, which can ultimately degrade controller performance.

Another problem arises in existing systems when customer-specific or application-specific functions are added to a certified controller application. Usually certification is lost, because it is not possible to separate a certified base function from additional functions.

Thus the object of the present invention is to provide a programmable controller that enables both good performance of the controller and straightforward customization of the automation system to the requirements of the user.

This object is achieved by the programmable controller having the features of claim 1, where the programmable controller comprises a first area for storing and running control codes for automation units, programmed in a first programming language, and a second area, which is connected to the first area via at least one interface, and where the second area can be programmed in a programming language that is different from the first programming language.

The first programming language is preferably a programming language common in automation engineering, such as that of STEP 7, and the second programming language an object oriented programming language, in particular Java. The known programming software Step 7 has the advantage that good performance is still achieved for the controller of the automation units. JAVA has the advantage that as an object oriented language it is also relatively easy to understand for the user and can hence be used easily. Thus according to the invention, the control codes can continue to be written on the programmable controller in a programming language that is common in, and suitable for, automation engineering.

In addition, however, additional user-specific routines such as diagnostic functions or additional automation functions can be written on the same programmable controller in the simplest fashion by a user, thereby enabling user-specific expansion of the automation system.

Thus, in particular by dividing the programmable controller into two areas, where the first area contains control codes that are certified for a specific number of automation units and protected against changes, and the second area is programmable with free access, additional user-specific automation functions or diagnostic functions can be programmed in the simplest fashion in the second area, without the actual core routines saved in the first protected area needing to be changed. It can thus be ensured that the previously created and certified control codes for the core routines for operating the automation system cannot be changed easily, which might otherwise forfeit certification of the programmable controller.

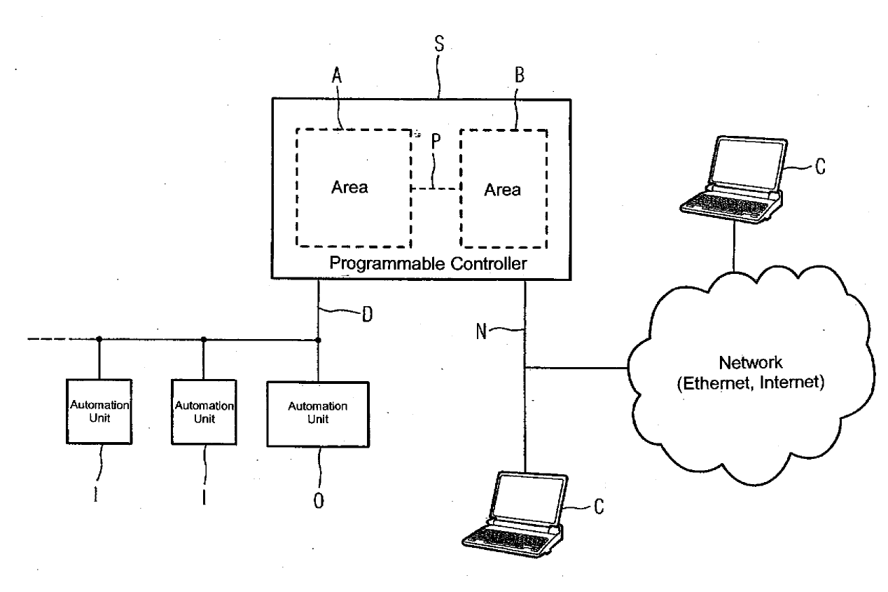

The invention and its further advantages shall now be described in more detail below with reference to FIG. 1. FIG. 1 shows schematically a programmable controller S having a first area A and a second area B. Both areas A and B are shown dashed here to indicate that the two areas need not necessarily be physically separate inside the programmable controller. As indicated, both areas A and B are connected together via at least one interface P, preferably a high-performance, highly proprietary interface. The programmable controller S is connected to the relevant automation units I, O via an additional interface D such as a Profibus-DP known in automation engineering. These automation units may, for instance, be individual actuators or sensors, complete units or sub-assemblies etc. inside the automation system, which during operation communicate with the programmable controller in the suitably programmed manner and execute the programmed automation functions. Additional interfaces such as an interface N can be provided in order to connect to the programmable controller, via an Ethernet or Internet, for example, additional units such as operating and monitoring units.

A single programmable controller is thus divided according to the invention into two sub-areas A and B, where both sub-areas can be programmed in different programming languages, in particular a first area in a programming language common in automation engineering, and a second area in a simpler object oriented programming language. Thus, for example, all the essential control codes for operating the automation system and hence communicating with the units I and O connected to the automation system are saved in area A. This first area A can be protected against unauthorized changes, thereby ensuring secure control of automation units by the programmable controller, which then ultimately also enables suitable certification of this programmable controller. The second area B is freely programmable, in particular in an object-oriented programming language such as JAVA, in order to give the user the opportunity to add additional user-specific routines as simply as possible. Since, as a rule, such user-specifically written routines also access data from the actual controller from area A, a high-performance, proprietary interface P is provided between the two areas A and B. For example, the process variables and data known in area A can thus be accessed by the diagnostic routines written user-specifically in area B via this interface P in order to analyze this data.

In addition, routines could be written in area B that forward this data from area A via the interface N to other units C such as web servers etc. In addition, routines could also be written in area B that implement quite specific user-related automation functions for which the programmable controller does not need to be certified however.

To summarize, it can be stated that by the present invention, namely dividing the programmable controller into a first area (A) and a second area (B), which are loosely coupled together, the following advantages can be obtained:
Simple addition of user-specific routines and hence automation functions in any programming language in area B, without the actual control codes in area A being changed. The system integrity of the programmable controller thereby remains intact despite the opportunity for user-related changes. Thus, for example, even a program accidentally written incorrectly by the user in area B will not result in an error in the control code in area A and thus associated failure of the complete controller S of the automation system.
Better performance compared with systems in which user-specific routines such as diagnostic functions are implemented by means of additional equipment (e.g. additional PC or web connection);
Simple addition of user-related routines because object-oriented programming tools such as JAVA are widely used. Thus standard web services, in particular, can be implemented in area B and hence integrated in the automation system in the simplest fashion by suitable programming in JAVA.

1.-3. (canceled)

4. A programmable controller for use in automation systems, comprising:
a first area for storing and running control codes for automation units, said first area programmed in a first programming language, and
a second area connected to the first area via at least one interface, said second area programmed in a programming language that is different from the first programming language,
wherein the first area contains control codes that are certified for a specific automation application and protected against changes, and the second area is programmable with free access.

5. The programmable controller of claim 4, wherein the first programming language is a programming language common in automation engineering, and the second programming language is an object-oriented programming language.

6. The programmable controller of claim 4, wherein the first area is connected to the second area via the at least one interface.

7. The programmable controller of claim 6, wherein the interface is a proprietary interface.

8. The programmable controller of claim 5, wherein the object-oriented programming language is Java.
